(19) United States
(12) Patent Application Publication
(10) Pub. No.: US 2005/0240882 A1
(43) Pub. Date: Oct. 27, 2005

(54) Method and system for displaying regions of pathological interest

(75) Inventors: Mark M. Morita, Arlington Heights, IL (US); Steven L. Fors, Chicago, IL (US); Khal A. Rai, Round Lake, IL (US); Carson H. Thomas, Brookfield, WI (US)

Correspondence Address: Joseph D Kuborn;ANDRUS SCEALES STARKE & SAWALL, 100 East Wisconsin Avenue Suite 1100, Milwaukee, WI, 53202, US

(73) Assignee: GE Medical Systems Information Technologies, Inc.

(21) Appl. No.: 10/828,684

(22) Filed: Apr. 21, 2004

(51) Int. Cl. G06F 9/00

(52) U.S. Cl. 715/964; 715/764

(57) ABSTRACT

A method and system which may be used to display a number of computer-detected regions of pathological interest using interactive CAD markers are presented. In one embodiment, a layer of uniquely identified CAD markers corresponding to computer-detected regions of pathological interest of an anatomical feature may be simultaneously displayed with an image of the anatomical feature. Each individual CAD marker may be configured to incorporate viewable classification data entered by a user and may further be configured to visually indicate the probability of cancer determined by the CAD algorithm. Each individual CAD marker and the information associated therewith may also be saved with the image such that it may be incorporated into, for example, a structured reporting system.

### BACKGROUND OF THE INVENTION

The present description relates generally to methods and systems for viewing medical images. In particular, the present description relates to a method and system for displaying identified regions of pathological interest using interactive CAD markers which contain unique visual identification data.

Computer Aided Detection (CAD) technology is presently used in conjunction with various types of early detection cancer screening technologies, such as digital mammography, to assist radiologists and physicians in identifying suspicious lesions and other potential regions of pathological interest. CAD technology typically employs a computer-implemented algorithm to analyze an image of a particular anatomical feature, such as a breast or lung, and identify regions on the image of characteristics commonly associated with cancerous pathology. The CAD algorithm may also determine the probability of cancer for each detected region of the anatomical feature in the image. The image of the anatomical feature is displayed on an image viewing station for review by a radiologist or physician, wherein the CAD-detected regions of pathological interest are indicated by a visible layer of CAD markers.

When reviewing an image, radiologists and physicians need a convenient way to distinguish among the various CAD markers. Additionally, radiologists viewing the image need a way to view the probability of cancer determined by the CAD algorithm for each detected region. Further, a high percentage of CAD-detected regions are false-positive detections. Thus, a radiologist reviewing an image needs a way to indicate to a physician which CAD markers in his or her opinion correspond to false-positive detections and those which do not. Additionally, physicians and radiologists need a convenient way of directly referencing the layer of CAD markers in a radiology report. Thus, there is need for an improved method and system for displaying CAD detected regions of pathological interest using interactive CAD markers.

### SUMMARY OF THE INVENTION

According to a first exemplary embodiment, a method for displaying a number of computer-detected regions of pathological interest of an anatomical feature includes displaying an image of the anatomical feature; and simultaneously displaying with the image a uniquely identified marker corresponding to each computer-detected region of pathological interest; wherein each marker is generated from the image by a computer-implemented detection algorithm and is configured to incorporate viewable classification data entered by a user.

According to a second exemplary embodiment, a method for interactively displaying a number of unique locations of pathological interest of an anatomical feature includes displaying an image of the anatomical feature; simultaneously displaying with the image a uniquely identified marker corresponding to each location of pathological interest; receiving a first user-input command that selects one of the uniquely identified markers for classification; displaying a menu of user-selectable classification alternatives in response to the first user-input command; receiving a second user-input command that selects one of the user-selectable classification alternatives; and modifying the visual appearance of the displayed marker in response to the classification alternative selected by the second user-input command.

According to a third exemplary embodiment, a system for displaying a number of unique locations of pathological interest of an anatomical feature detected by a computer-implemented detection algorithm includes storage media including an image of the anatomical feature and the locations of pathological interest of the anatomical feature detected by the computer-implemented detection algorithm; a processor coupled to the storage media and operable to generate a uniquely identified marker corresponding to each computer-detected region of pathological interest, wherein each marker is configured to incorporate viewable classification data entered by a user; a display coupled to the processor and configured to simultaneously display the image of the anatomical feature and each marker; and a user-input device coupled to the processor and operable to select one of the markers and enter classification data.

According to a fourth exemplary embodiment, in a computer implemented method for displaying a number of detected locations of pathological interest of an anatomical feature, a marker for uniquely identifying each location of pathological interest and embodied in a computer-readable medium and capable of being displayed includes a unique identifier for the location of pathological interest; and a visual indication of the probability of cancer for each location of pathological interest; wherein the marker is configured to incorporate viewable classification data based on user input.

### BRIEF DESCRIPTION OF THE DRAWINGS

FIG. 1 is a diagram of a system for displaying a number of computer-detected regions of pathological interest of an anatomical feature according to an exemplary embodiment.

FIG. 2 is a flow diagram depicting a method for displaying a number of computer-detected regions of pathological interest of an anatomical feature according to an exemplary embodiment.

FIG. 3 is a flow diagram depicting a method for interactively displaying a number of unique locations of pathological interest of an anatomical feature according to an exemplary embodiment.

FIG. 4 illustrates several uniquely identified interactive CAD markers according to an exemplary embodiment.

### DETAILED DESCRIPTION

Turning now to the FIGURES which illustrate exemplary embodiments, a method and system are shown which may be used to display a number of computer-detected regions of pathological interest using interactive CAD markers. In one embodiment, a layer of uniquely identified CAD markers corresponding to computer-detected regions of pathological interest of an anatomical feature may be simultaneously displayed with an image of the anatomical feature. Each individual CAD marker may be configured to incorporate viewable classification data entered by a user and may further be configured to visually indicate the probability of cancer determined by a CAD algorithm. Each individual CAD marker and the information associated therewith may also be saved with the image such that it may be incorporated into, for example, a structured reporting system. These features allow for smoother workflow between, for example, radiologists and physicians, and improved ease of differentiation and prioritization of each region of pathological interest indicated by each CAD marker.

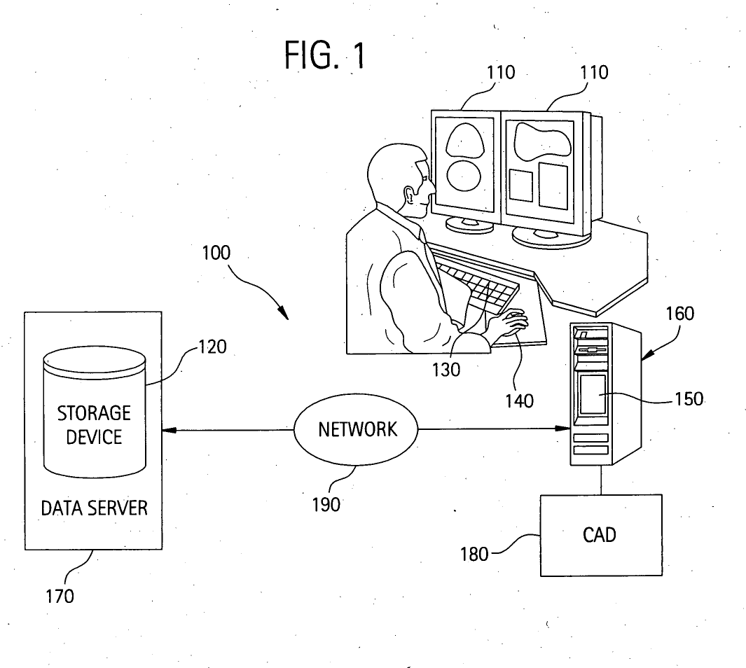

Referring now to FIG. 1, a system 100 for displaying a number of computer-detected regions of pathological interest of an anatomical feature according to an exemplary embodiment is shown. System 100 may be a wide variety of systems used for radiology information management, image communication, and/or image viewing purposes. System 100 may be configured as part of a network of computers or as a stand-alone system. In one embodiment, system 100 may be an internet-based-workstation coupled to a central data server as part of a network 190 which provides access to radiology information and images.

System 100 may comprise a display 110, a storage device 120, and a user-input device such as keyboard 130 and/or mouse 140, all of which may be communicatively coupled to a processor 150. The configuration shown in FIG. 1 is only one of many suitable configurations. For example, system 100 may include any number of displays 110. In the illustrated embodiment, two displays 110 are shown. In another embodiment, the user-input device may include a voice activated input device to allow voice commands. In embodiments where system 100 is configured as part of a network, storage device 120 and/or processor 150 may be part of a central server and remotely coupled to display 110 and the user-input device. For example, in the illustrated embodiment, processor 150 is housed in cabinet 160 and is coupled to display 110, keyboard 130, and mouse 140 as part of a workstation, and storage device 120 is remotely coupled to processor 150 as part of a central data server 170 via network 190.

Display 110 may be configured to provide output to a user in the form of information, which may include, for example, alphanumeric output (e.g., text, numbers, etc.) and graphical image output (e.g., radiology images using various imaging technologies). Particularly, display 110 may be configured to simultaneously display an image of an anatomical feature and a series of CAD markers corresponding to regions of pathological interest of the anatomical feature. Display 110 may be any number of suitable displays in a number of suitable configurations. For example, display 110 may be a liquid crystal display (LCD), flat screen display, cathode ray tube (CRT) display, SVGA display, VGA display, etc. Display 110 may be further configured to directly receive input from a user (e.g., touch screen, buttons located adjacent to the screen, etc.).

The user-input device may include, for example, keyboard 130, mouse 140, and/or a voice-activated input device (not shown) or touch screen device (not shown) or buttons (not shown) incorporated as part of display 110. The user-input device may be used, for example, to input commands to select one or more individual CAD markers displayed on display 110 and to enter classification data for each selected CAD marker. In the illustrated embodiment, mouse 140 may be used to select one or more individual CAD markers displayed on display 110 and to enter classification data for each selected CAD marker from an electronically displayed menu using a “point and single click” or “point and double click” command. In another embodiment, the user input device may be a voice-activated input device and voice commands may be used to select one or more CAD markers and to input classification data.

Storage device 120 may include any computer-readable storage media suitable for storing radiology images and information for later retrieval, such as, for example, a magnetic storage disk, optical storage disk, etc. In the illustrated embodiment, storage device 120 is housed in a central data server and may store radiology images and data to be accessed by a number of workstations connected as part of a network. In another embodiment, storage device 120 may be incorporated into system 100 where system 100 is a stand-alone system. Storage device 120 may store images and data according to any format or protocol. In one embodiment, storage device 120 may store medical or radiology images and data using a standard DICOM protocol. Storage device 120 may also store each of the displayed CAD markers with the image of the anatomical feature such that the information may be directly accessed by accessing the image from a structured reporting system.

Processor 150 may be used in conjunction with CAD system 180 to generate a number of uniquely identified CAD markers corresponding to a number of computer-detected regions of pathological interest, wherein each CAD marker is configured to incorporate viewable classification data entered by a user. Each region of pathological interest of the anatomical feature may be detected from an image of an anatomical feature by CAD system 180 using a detection algorithm, which may also determine a probability of cancer for each region. Processor 150, in conjunction with CAD system 180, may then use this information to generate a uniquely-identified CAD marker for each region which is configured to visually indicate the probability of cancer for the region, as well as any classification data input by a user via commands from mouse 140 or other input device.

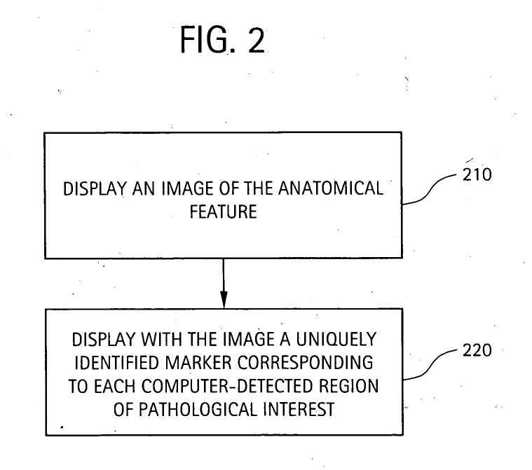

Referring now to FIG. 2, a method for displaying a number of computer-detected regions of pathological interest of an anatomical feature using CAD markers according to an exemplary embodiment is shown. At step 210, an image of the anatomical feature may be retrieved from storage device 120 and displayed on display device 110. At step 220, a uniquely identified CAD marker for each computer-detected region of pathological interest may be simultaneously displayed with the image on display device 110. Each individual CAD marker may be uniquely identified in any number of ways. In one exemplary embodiment, each individual CAD marker may be uniquely identified by an alphanumeric label or other symbol adjacent to the CAD marker, which may be a single character (e.g., A, B, C, etc.) or a string of text or characters. Other exemplary embodiments include the use of the shape, size, or color of the CAD marker as a unique identifier.

As stated above, each CAD marker may be generated from the image of the anatomical feature by processor 150 using data from CAD system 180, which employs a computer-implemented detection algorithm to detect regions of potential pathological interest as well as the probability of cancer for each region. Accordingly, each individual CAD marker may be configured to visually indicate the probability of cancer for the region determined by the CAD algorithm. For example, in one exemplary embodiment, the CAD-determined probability of cancer for each region may be visually indicated on display 110 by the particular shade (e.g., lightness or darkness) of color of each CAD marker. In another embodiment, different hues may be used to indicate the probability of cancer for each region. Other exemplary embodiments may include varying the size or shape of the CAD marker according to the CAD-detected probability of cancer, or by indicating the probability using alphanumeric characters or other symbols adjacent to the CAD marker.

Each individual CAD marker may be further configured to incorporate viewable classification data entered by a user via the user input device (e.g., mouse 140). Viewable classification data may include, for example, any data or information entered by a user such as a radiologist upon reviewing the image that is relevant to the region corresponding to each CAD marker and which may aid in distinguishing among the various CAD markers displayed on display 110. For example, in one exemplary embodiment, viewable classification data may include a visual indication that the radiologist viewing the image has determined that a particular CAD marker corresponds to a computer-detected region which is a false-positive detection, a microcalcification, a nodule, or a cyst. Other exemplary embodiments may include other types of classification data provided by the user depending upon the specific application or the anatomical feature. The visual appearance of each individual CAD marker may indicate the classification data that is entered by the user. In one exemplary embodiment, each CAD marker is configured to visually indicate the viewable classification by the color of the marker. Other exemplary embodiments may include varying the size or shape of the CAD marker according to the CAD-detected probability of cancer, or by indicating the classification data using alphanumeric characters or other symbols adjacent to the CAD marker.

Each individual CAD marker may be further configured to be electronically stored with the image of the anatomical feature in storage device 120. In this way, the data associated with each CAD marker (e.g., probability of cancer, user-entered classification data, etc.) may be referenced directly by, for example, a reviewing physician by accessing the image, or by accessing a structured radiology report which includes the image as an attachment.

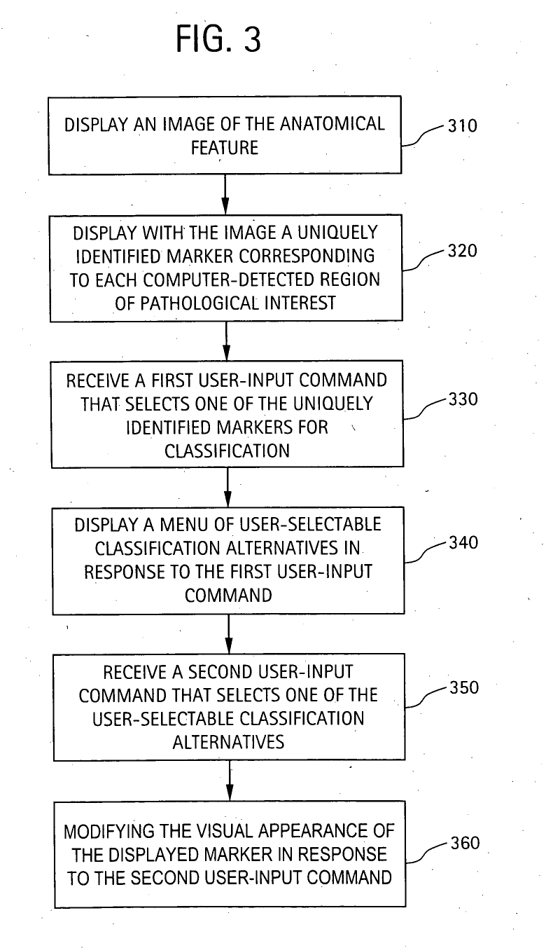

Viewable classification data may be entered by a user in a number of ways. For example, referring now to FIG. 3, a method for interactively displaying a number of unique locations of pathological interest of an anatomical feature using CAD markers according to an exemplary embodiment is shown. Steps 310 and 320 are similar to steps 210 and 220 respectively. At step 310, an image of the anatomical feature may be retrieved from storage device 120 and displayed on display device 110. At step 320, a uniquely identified CAD marker for each computer-detected region of pathological interest may be simultaneously displayed with the image on display device 110.

At step 330, a first user-input command may be received by system 100 that selects one of the uniquely identified CAD markers for classification. For example, in one exemplary embodiment, the first user-input command may be entered by a user, such as a radiologist reviewing the image, by positioning a cursor over one of the uniquely identified CAD markers using mouse 140 and then executing a single click or double click command. In another embodiment, the first user-input command may be a voice command entered using a voice-activated input device. In yet another embodiment, the first user-input command may be entered using keyboard 130.

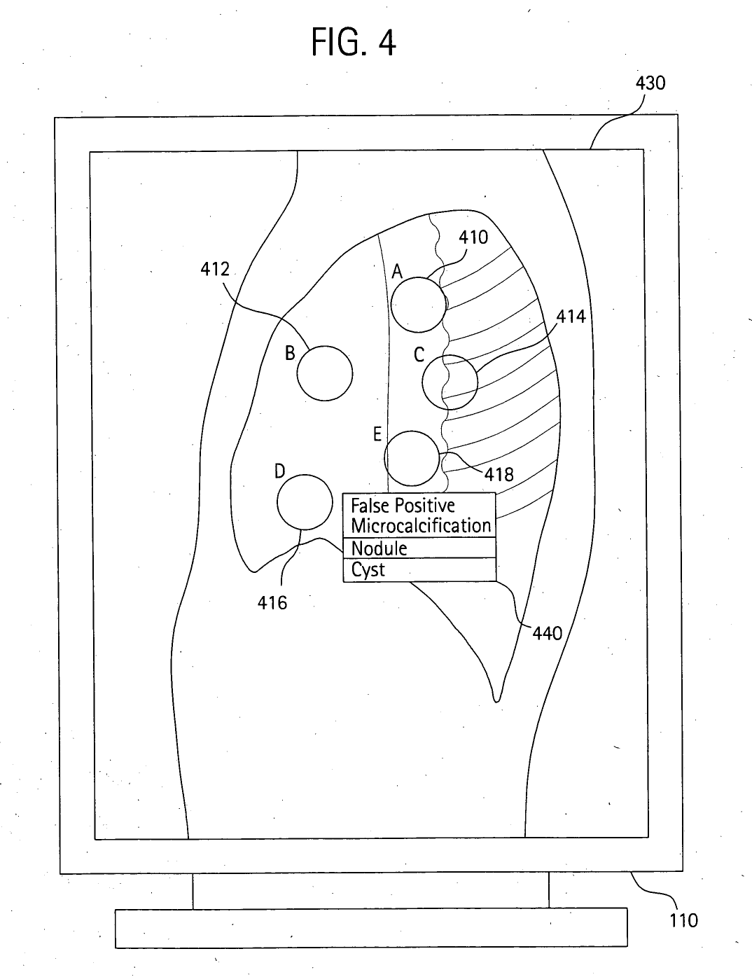

At step 340, a menu of user-selectable classification alternatives may be displayed on display 110 in response to the first user-input command. For example, in one exemplary embodiment, a “pop-up” menu of user-selectable alternatives (best illustrated in FIG. 4) is displayed adjacent to and/or proximate to the CAD marker selected using mouse 140 in step 330. The menu of user-selectable alternatives may contain, for example, a predetermined list of user-selectable classifications which may be relevant to the region corresponding to each CAD marker and which may aid in distinguishing among the various CAD markers displayed on display 110. For example, in one exemplary embodiment, the menu of user-selectable alternatives may include a list of classifications such as “false-positive,” “microcalcification,” “nodule,” “cyst,” etc. Other exemplary embodiments may include other types of predetermined user-selectable classifications depending upon the specific application or the anatomical feature.

At step 350, a second user-input command may be received by system 100 which selects one of the user-selectable classification alternatives from the menu displayed on display 100 in step 340. For example, in one exemplary embodiment, the second user-input command may be entered by the user by positioning the cursor over one of the user-selectable classification alternatives using mouse 140 and then executing a single click or double click command. The menu selection over which the cursor is placed may be highlighted on display 110 to indicate that selection that will be entered upon executing the single or double click command. In another embodiment, the second user-input command may be a voice command entered using a voice-activated input device. In yet another embodiment, the first user-input command may be entered using keyboard 130.

At step 360, the visual appearance of the CAD marker selected by the user at in step 330 may be modified in response to the classification alternative selected by the user in step 340 and received by system 100 in step 350. For example, in one exemplary embodiment, the color (e.g., shading or hue) of the CAD marker selected by the user in step 330 may be modified to reflect the classification selected from the menu in step 340. Other exemplary embodiments may include varying the size or shape of the CAD marker according to the CAD-detected probability of cancer, or by indicating the classification data using alphanumeric characters or other symbols adjacent to the CAD marker.

In this way, a user such as a radiologist reviewing the image of the anatomical feature in display 110 may provide further useful differentiation between each of the regions of pathological interest identified by the CAD algorithm by entering classification data reflecting his or her opinion as to the identification or significance of each detected region. Each individual CAD marker may then provide a visual indication to a reviewing physician that the radiologist viewing the image has determined that a particular CAD marker corresponds to a computer-detected region which may be, for example, a false-positive detection, a microcalcification, a nodule, or a cyst. Thus, a reviewing physician may more effectively and efficiently differentiate between each of the CAD markers and interpret each region of pathological interest identified in the image. Because the classification data entered by the radiologist for each individual CAD marker may be saved with the image and, for example, incorporated into a structured radiology report, the information contained in each individual CAD marker may be accessed by a reviewing physician without having to separately reference the layer of CAD markers. Accordingly, workflow between the radiologist and physician is improved.

Referring now to FIG. 4, several uniquely identified interactive CAD markers are illustrated according to an exemplary embodiment. Interactive CAD markers 410, 412, 414, 416, and 418 each correspond to a region of pathological interest detected by a CAD algorithm for the lung shown in image 430. Each of the interactive CAD markers is shown with an adjacent unique alphanumeric identifier such that “A” corresponds to CAD marker 410, “B” corresponds to CAD marker 412, “C” corresponds to CAD marker 414, “D” corresponds to CAD marker 416, and “E” corresponds to CAD marker 418.

Interactive CAD markers 410, 412, and 418 each illustrate a visual indication of the probability of cancer for the region of pathological interest in image 430 to which they correspond. In the illustrated embodiment, each probability is indicated by the shade of color of the CAD marker. For example, CAD marker 410, which is shaded the lightest shade of white, corresponds to a CAD-detected region of pathological interest with a 75-100% CAD-determined probability of cancerous pathology. CAD marker 412, which is a slightly darker shade of white, corresponds to a CAD-detected region of pathological interest with a 50-75% CAD-determined probability of cancerous pathology. CAD marker 418, which is an even darker shade of white, corresponds to a CAD-detected region of pathological interest with a 25-50% CAD-determined probability of cancerous pathology.

Interactive CAD markers 414 and 416 each illustrate a the use of the color of the CAD marker to visually indicate the viewable classification data entered by a user. For example, the black color of interactive CAD marker 414 illustrates that the corresponding CAD-detected region of pathological interest has been classified by as a false positive by the reviewing radiologist. CAD marker 416 illustrates the use of an electronically displayed menu 440 to classify the corresponding region. In the illustrated embodiment, menu 440 includes the predefined user-selectable classifications “false-positive,” “microcalcification,” “nodule,” and “cyst.” The user-selectable classification “nodule” is shown highlighted in the menu to indicate that this is the selection being made. The lighter black shade of interactive CAD marker 416 illustrates that the corresponding CAD-detected region of pathological interest has been classified as a nodule by the reviewing radiologist. While shading is used in the illustrated embodiment to further differentiate between interactive CAD markers 410-418, it should be noted that many other differentiation schemes are possible. For example, greyscale shading may be used to differentiate between CAD markers 410, 412, and 418 as to the CAD-determined probability of cancerous pathology for each corresponding CAD-detected region, while the hue of CAD markers 414 and 416 may be used to indicate the viewable classification data entered by the user such that the color of CAD marker 414 may be blue to indicate a false positive classification, while the color of CAD marker 416 may be red to indicate classification as a nodule.

It should be understood that the exemplary embodiments illustrated in the figures and described above are offered by way of example only. Many modifications are possible without materially departing from the novel teachings and advantages of the subject matter recited in the claims. For example, various other types of classification data than those described herein may be provided by the user depending upon the specific application or the anatomical feature. Further, in addition to color, the size and shape of a CAD marker, or alphanumeric text adjacent to the CAD marker may additionally or alternatively be varied to provide differentiation or convey information. Accordingly, all such modifications are intended to be included within the scope of the methods and systems described herein. The order and sequence of any process or method steps may be varied or re-sequenced according to other embodiments. Other substitutions, modifications, changes, and omissions may be made without departing from the spirit and scope of the methods and systems described herein.

1. A method of displaying a number of computer-detected regions of pathological interest of an anatomical feature, the method comprising:
displaying an image of the anatomical feature; and
simultaneously displaying with the image a uniquely identified marker corresponding to each computer-detected region of pathological interest;
wherein each marker is generated from the image by a computer-implemented detection algorithm and is configured to incorporate viewable classification data entered by a user.

2. The method of claim 1, wherein each marker is uniquely identified by a label adjacent to the marker.

3. The method of claim 1, wherein the computer-implemented detection algorithm determines a probability of cancer for each region of pathological interest.

4. The method of claim 3, wherein each marker is configured to visually indicate the probability of cancer determined by the computer-implemented detection algorithm.

5. The method of claim 4, wherein the color of each marker visually indicates the probability of cancer determined by the computer-implemented detection algorithm.

6. The method of claim 1, wherein the viewable classification data entered includes a user-determined classification of the computer-detected region as a false-positive detection.

7. The method of claim 1, wherein the viewable classification data includes a user selection of the classification data from an electronically displayed menu of alternative classifications.

8. The method of claim 1, wherein each marker is configured to visually indicate the viewable classification data by the color of the marker.

9. The method of claim 1, wherein each marker is configured to be electronically stored with the image in a computer-readable medium.

10. A method of interactively displaying a number of unique locations of pathological interest of an anatomical feature, the method comprising:
displaying an image of the anatomical feature;
simultaneously displaying with the image a uniquely identified marker corresponding to each location of pathological interest;
receiving a first user-input command that selects one of the uniquely identified markers for classification;
displaying a menu of user-selectable classification alternatives in response to the first user-input command;
receiving a second user-input command that selects one of the user-selectable classification alternatives; and
modifying the visual appearance of the displayed marker in response to the classification alternative selected by the second user-input command.

11. The method of claim 10, wherein each marker is uniquely identified by a label adjacent to the marker.

12. The method of claim 10, wherein the first user-input command is a mouse command which selects one of the uniquely identified markers for classification.

13. The method of claim 10, wherein the second user-input command is a mouse command which selects one of the user-selectable classification alternatives.

14. The method of claim 10, wherein modifying the visual appearance of the displayed marker in response to the classification alternative selected by the second user-input comprises changing the color of the displayed marker.

15. The method of claim 10, wherein each marker is configured to be electronically stored with the image in a computer-readable medium.

16. A system for displaying a number of unique locations of pathological interest of an anatomical feature detected by a computer-implemented detection algorithm, the system comprising:
storage media including an image of the anatomical feature and the locations of pathological interest of the anatomical feature detected by the computer-implemented detection algorithm;
a processor coupled to the storage media and operable to generate a uniquely identified marker corresponding to each computer-detected region of pathological interest, wherein each marker is configured to incorporate viewable classification data entered by a user;
a display coupled to the processor and configured to simultaneously display the image of the anatomical feature and each marker; and
a user-input device coupled to the processor and operable to receive a selection of one of the markers and enter classification data.

17. The system of claim 16, wherein the user-input device comprises a mouse.

18. The system of claim 16, wherein each marker is configured to be electronically stored with the image in a computer-readable medium.

19. The system of claim 16, wherein each marker is uniquely identified by a label adjacent to the marker.

20. The system of claim 16, wherein the viewable classification data entered includes a user-determined classification of the computer-detected region as a false-positive detection.

21. The system of claim 16, wherein the viewable classification data includes a user selection of the classification data from an electronically displayed menu of alternative classifications.

22. The system of claim 16, wherein each marker is configured to visually indicate the viewable classification data by the color of the marker.

23. The system of claim 16, wherein the computer-implemented detection algorithm determines a probability of cancer for each region of pathological interest.

24. The system of claim 23, wherein each marker is configured to visually indicate the probability of cancer determined by the computer-implemented detection algorithm.

25. The system of claim 24, wherein the color of each marker visually indicates the probability of cancer determined by the computer-implemented detection algorithm.

26. A marker for use with a graphical user interface for uniquely identifying a location of pathological interest, the marker comprising:
a unique identifier for the location of pathological interest; and
a visual indication of the probability of cancer for the location of pathological interest;
wherein the marker is configured to incorporate viewable classification data based on user input.

27. The marker of claim 26, wherein the unique identifier comprises a label adjacent to the marker.

28. The marker of claim 26, wherein the visual indication of the probability of cancer for the location of pathological interest is indicated by the color of the marker.

29. The marker of claim 26, wherein the viewable classification data includes a user selection of the classification data from an electronically displayed menu of alternative classifications.

30. The marker of claim 26, wherein the marker is configured to visually indicate the viewable classification data by the color of the marker.

31. The marker of claim 26, wherein the viewable classification data includes a user-determined classification of the region as a false-positive detection.

32. The marker of claim 26, wherein the viewable classification data includes a user-determined classification of the region as a cyst.

33. The marker of claim 26, wherein the viewable classification data includes a user-determined classification of the region as a nodule.

34. The marker of claim 26, wherein the viewable classification data includes a user-determined classification of the region as a microcalcification.
